(19) United States
(12) Patent Application Publication
(10) Pub. No.: US 2002/0151637 A1
(43) Pub. Date: Oct. 17, 2002

(54) Polymeric structural support membrane

(76) Inventors: Hendrik Johannes G. Pretorious, Potchefstroom (ZA); Lynn E. Brower, Solon, OH (US); Frank V. Apicella JR., Hiram, OH (US)

Correspondence Address: JOSEPH G CURATOLO, ESQ., RENNER KENNER GREIVE BOBAK TAYLOR & WEBER, 24500 CENTER RIDGE ROAD, SUITE 280, WESTLAKE, OH, 44145, US

(21) Appl. No.: 10/068,124

(22) Filed: Feb. 5, 2002

Related U.S. Application Data
(60) Provisional application No. 60/267,301, filed on Feb. 8, 2001.

(51) Int. Cl. C08K 3/34

(52) U.S. Cl. 524/445; 524/449; 524/558; 524/127; 524/432; 524/431

(57) ABSTRACT

A polymeric structural support membrane composed of a polymer that is an initiator induced reaction product of a monomer, an initiator, and optionally a crosslinking agent; and a fire retardant is applied to the surfaces of an excavation to provide structural support. The polymer is a reaction product of a monomer that can be monofunctional, di-functional, tri-functional, tetra-functional and mixtures thereof. The membrane formed has a tensile strength and a thickness sufficient to provide support to the exposed surfaces in the excavation and can be applied by spraying, brushing, or rolling. In an alternative embodiment the membrane can be applied by pumping.

### FIELD OF THE INVENTION

The present invention is directed to structural support coverings for excavations, such as mines. More particularly, the present invention is directed to a polymeric membrane that is applied to the surfaces of an excavation to provide structural support.

### BACKGROUND OF THE INVENTION

When ground is excavated, structural supports are placed in the excavation to prevent the ground from collapsing into the excavated area. Mainly, the ground is supported by support rods that are placed along the excavation. These supports are typically steel reinforcing rods that are held in place by mechanical anchors and/or grouts. These supports provide the main protection against unplanned rock falls.

The excavation, however, exposes natural rock features, such as faults and joints, and can damage the ground by digging or blasting. In these excavations, such as mines, supports are needed to prevent rock falls. Structural beams provide the main support in the excavation to prevent major rock falls. However, minor rock falls can occur between the main supports. Even though they may be isolated or relatively small, they still pose a hazard to people working in the excavation.

To prevent these minor rock falls between the supports, wire screens or mesh have been installed between the main supports. There are many disadvantages to using a wire screen. The screen requires labor intensive installation. The screen offers no protection against weathering of the rock face. Because of the unevenness of the rock face, the screen is not fully flush with the rock face. The screen only becomes effective after considerable rock movement puts tension on the screen. The screen is prone to corrosion and deterioration. The screen is prone to blasting damage if it is installed close to the advancing face. Because it cannot be installed remotely, it is hazardous to install because of falling rock. It can be difficult to shotcrete over which causes relatively high rebound and lower substrate adhesion.

One possible alternative to a wire mesh would be to spray concrete (shotcrete) onto the rock face. However, this would be cost prohibitive to apply to all surfaces in an excavation. Also, shotcreting may not be able to be applied in all locations.

Sealants have been used in mines to prevent air leaks. Sealants, however, are not capable of providing structural support to a surface in an excavation. Generally, sealants are polymer in water dispersions. As a result, they cannot be applied to a surface at a thickness sufficient to provide support because of the water content. Also, the polymer in water dispersion prohibits quick setting of the polymer on the surface, which in turn does not provide sufficient tensile strength.

What is needed in the art is a structural membrane that can be installed with minimal labor, can be installed remotely from the exposed rock face, offers weathering protection to the rock face, does not corrode, becomes effective with minimal rock deformation, can be applied near the advancing face, is less prone to blast damage, and can be covered with shotcrete if deemed necessary.

It is desirable for the invention to provide a polymeric structural support membrane for providing support to exposed surfaces in an excavation.

It is also desirable for the invention to provide a polymeric structural support membrane that has a tensile strength and thickness, and molecular weight that are sufficient to provide support to exposed surfaces in an excavation.

### SUMMARY OF THE INVENTION

The present invention provides a polymeric excavation structural support membrane comprising a polymer that is an initiator induced reaction product of a monomer; a fire retardant; and optionally at least one of a crosslinking agent, a second monomer, a smoke retardant, a rheology modifier, reaction rate modifier, a plasticizer, emulsifier, defoamer, filler, wet surface adhesion modifier, and coloring agent; wherein the monomer is selected from the group consisting of aryloxy alkyl acrylates, aryloxy alkyl methacrylates, and mixtures thereof; wherein the second monomer does not homopolymerize in the presence of the reaction rate modifier or the initiator; wherein the membrane has a tensile strength and thickness sufficient to provide support to exposed surfaces in an excavation.

A method of reinforcing exposed surfaces in an excavation with a polymeric structural support membrane comprising: applying to the exposed surface a mixture comprising a monomer; an initiator, a fire retardant; and optionally at least one of a crosslinking agent, a second monomer, a smoke retardant, a rheology modifier, reaction rate modifier, a plasticizer, emulsifier, defoamer, filler, wet surface adhesion modifier, and coloring agent; wherein the monomer is selected from the group consisting of aryloxy alkyl acrylates, aryloxy alkyl methacrylates, and mixtures thereof, wherein the second monomer does not homopolymerize in the presence of the reaction rate modifier or the initiator; and reacting the mixture; wherein the membrane has a tensile strength and thickness sufficient to provide support to the exposed surfaces in the excavation.

The present invention also provides a polymeric structural support membrane formed from the process comprising: applying to an exposed surface in an excavation a mixture comprising a monomer; an initiator, a fire retardant; and optionally at least one of a crosslinking agent, a second monomer, a smoke retardant, a rheology modifier, reaction rate modifier, a plasticizer, emulsifier, defoamer, filler, wet surface adhesion modifier, and coloring agent; wherein the monomer is selected from the group consisting of aryloxy alkyl acrylates, aryloxy alkyl methacrylates, and mixtures thereof, wherein the second monomer does not homopolymerize in the presence of the reaction rate modifier or the initiator; and reacting the mixture; wherein the membrane has a tensile strength and a thickness sufficient to provide support to the exposed surfaces in the excavation.

Preferably, the monomer is selected from the group consisting of monofunctional aryloxy alkyl acrylates, monofunctional aryloxy alkyl methacrylates, and mixtures thereof.

### DETAILED DESCRIPTION OF THE INVENTION

The present invention is directed to a polymeric structural support membrane for excavations. The membrane includes a polymer and a fire retardant.

The polymer is a reaction product of a monomer selected from the group consisting of monofunctional monomers, di-functional monomers, tri-functional monomers, tetra-functional monomers, and mixtures thereof. By functional, it is meant that the monomer has at least one double bond reactive group that can react in a polymerization reaction through a double bond to form a polymer. Additionally, the monomer can include another functional group, which can be a double bond or another reactive group, that reacts to link one polymer chain to another polymer chain.

The polymer is present in the membrane in an amount that provides the membrane with a tensile strength and thickness sufficient to provide support to exposed surfaces in an excavation. The polymer is generally present in an amount from about 30% to about 70% based on the weight of the membrane. In one embodiment, the polymer is present in the membrane from about 51% to about 70% based on the weight of the membrane.

The monofunctional monomers used according to the present invention are monofunctional esters, particularly monofunctional aryloxy alkyl acrylates, monofunctional aryloxy alkyl methacrylates, and mixtures thereof. The methacrylates are preferred because they produce less odor.

Examples of useful monofunctional aryloxy alkyl acrylates and monofunctional aryloxy alkyl methacrylates include, but are not limited to, 2-phenoxyethyl methacrylate, 2-phenoxy-propyl-methacrylate, and mixtures thereof. Other monofunctional monomers that can be reacted to form the membrane of the present invention include, but are not limited to, tri-propylene glycol diacrylate, tri-ethylene glycol dimethacrylate, and mixtures thereof.

The di-functional monomers can be any di-functional ester. Di-functional esters that can be used are di-functional aryloxy alkyl acrylates, di-functional aryloxy alkyl methacrylates, and mixtures thereof. Examples of useful di-functional monomers include, but are not limited to, tri-ethylene glycol dimethacrylate, neopentyl glycol diacrylate or methacrylate, and tri-propylene glycol diacrylate.

The tri-functional monomers can be any tri-functional ester. Tri-functional esters that can be used are tri-functional acrylates, tri-functional methacrylates, and mixtures thereof. Examples of useful tri-functional monomers include, but are not limited to, propoxylated trimethylolpropane triacrylate, ethoxylated trimethylpropane triacrylate, and propoxylated glyceryl triacrylate.

The tetra-functional monomers can be any tetra-functional esters. Tetra-functional esters that can be used are tetra-functional acrylates, tetra-functional methacrylates, and mixtures thereof. Examples of useful tri-functional monomers include, but are not limited to, di-trimethylolpropane tetra acrylate, and dipentaerythritol penta acrylate.

Preferably, the polymer is the reaction product of a monomer selected from the group consisting of monofunctional aryloxy alkyl acrylates, monofunctional aryloxy alkyl methacrylates, and mixtures thereof, and a crosslinking agent.

During the reaction process a selected monofunctional monomer forms polymers that crosslink by reacting with the crosslinking agent thereby providing structural support for the membrane. Suitable examples of the crosslinking agent include, but are not limited to, methylene bis acrylamide, polymethylmethacrylate, butadiene styrene acrylate, styrene butyl acrylate copolymer, 1,6-hexanediol dimethacrylate, ethoxylated bisphenol A dimethacrylate, polyethylene glycol dimethacrylate, and mixtures thereof. The crosslinking agent can be present up to about 30% based on the weight of the monomer.

A second monomer may be included in the reaction product that forms the membrane of the present invention. The second monomer preferably does not homopolymerize in the presence of the reaction rate modifier or the initiator. Suitable examples of the second monomer include, but are not limited to, diethylene glycol monoethyl ether dimethacrylate, diethylene glycol monobutyl ether dimethacrylate, and mixtures thereof.

Because the membrane is being applied in an excavation, particularly in a mine, there is the potential for fire. In each jurisdiction, there are requirements that the membrane be self extinguishing. The test is performed by holding the membrane to a flame for a fixed period of time. The membrane must then self extinguish itself within a set maximum time.

Provided in the membrane is a fire retardant. The fire retardant can be any material that provides self extinguishing properties to the membrane. Suitable examples of the fire retardant include, but are not limited to, phosphates, such as triphenyl phosphate, polyammonium phosphate, monoammonium phosphate, or tri(2-chloroethyl) phosphate, exfoliated graphite (which can be acid treated natural graphite flakes), and mixtures thereof. The fire retardant is preferably present in the membrane from about 5 to about 40% based on the weight of the membrane.

The fire retardant can be a liquid or a solid. Preferably the fire retardant is a solid. More preferably, the solid is micronized. By micronized it is meant that the solid is ground to a micron size. Additionally, the fire retardant includes but is not limited to self extinguishing agents and flame retardants. A preferred fire retardant is polyammonium phosphate. Optionally, an aluminum oxide smoke retardant is used in combination with the polyammonium phosphate.

As stated above, a smoke retardant can be provided in the membrane. A preferred smoke retardant is aluminum oxide (A1₂O₃). Preferably, the smoke retardant is present in the membrane from about 2% to about 15% based on the weight of the membrane.

The gel and set time of the membrane can be controlled by adding at least an initiator. The initiator can be an oxidizing agent. Suitable oxidizing agents include, but are not limited to, peroxides, such as benzoyl peroxide, dibenzoyl peroxide, hydroperoxides, such as cumyl hydroperoxide, persulfates, such as ammonium persulfate, and mixtures thereof. The initiator is preferably added in an amount from about 1% to about 10% based on the weight of the monomer.

In combination with the initiator, a reaction rate modifier, such as an accelerator, can be added. The reaction rate modifier can be a reducing agent. Suitable reducing agents include, but are not limited to, aniline containing compounds, amines, glycols, octoates, and mixtures thereof. Suitable examples of the reaction rate modifier include, but are not limited to, triethanolamine, N,N-dimethyl-p-toluidine, and tripropyl amines. The reaction rate modifier can be present in an amount up to about 10% based on the weight of the monomer.

The materials to form the membrane can either be provided as a single composition, or the materials can be provided as a two or more component formulation. The two or more component system may be desired when an initiator and a reaction rate modifier are being provided for in the membrane. In this instance, the initiator would be supplied in one component, and the reaction rate modifier could be supplied in another component.

The membrane can also include a rheology modifier to increase the viscosity of the membrane materials immediately after application to excavation surfaces. This may be desired to prevent the membrane from slumping before it cures when it is applied to a surface in an excavation. Suitable examples of the rheology modifier include fumed silica, hydroxyethyl cellulose, hydroxypropyl cellulose, fly ash (as defined in ASTM C618), mineral oils (such as light naphthenic), tetra alkyl ammonium hectorite clay, any other solids that are inert to the other materials in the membrane, and mixtures thereof. The rheology modifier can be present in an amount up to about 20% based on the weight of the membrane.

The membrane can also include an emulsifier. It may be desired to add an emulsifier to increase the adhesion of the membrane to a surface. The emulsifier can be any anionic surfactant or nonionic surfactant. Suitable examples of the emulsifier include, but are not limited to, ethoxylated nonyl phenol (preferably, the ethoxylated nonyl phenol contains from about 4 to about 10 ethylene oxide groups), lauryl sulfates and mixtures thereof. The emulsifier can be present in an amount up to about 5% based on the weight of the monomer.

The membrane can also contain a plasticizer to make the membrane more flexible. The plasticizer can be any material that plasticizes the polymer in the membrane. In one embodiment of the invention, the plasticizer allows the polymer to be self plasticizing. In this instance, the monomer is reacted with the plasticizer that incorporates itself into the reaction product. The plasticizer can be present in an amount up to about 40% based on the weight of the monomer. Suitable examples of the plasticizer include, but are not limited to, lauryl methacrylates, stearyl methacrylates, and ethoxylated(4) nonyl phenol (meth)acrylate, as shown by the following formula:

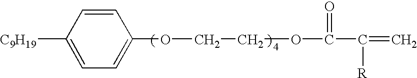

wherein R is H or CH₃.

The membrane can also include a filler. Suitable examples of the filler include, but are not limited to glass, such as crushed glass, metal such as iron particles, quartz, silica, barytes, limestone, sulfates, alumina, various clays, diatomaceous earth, wollastonite, mica, perlite, flint powder, kryolite, alumina trihydrate, talc, sand, pyrophylite, granulated polyethylene, fibers such as polypropylene or steel, zinc oxide, titanium dioxide, and mixtures thereof. A preferred filler is titanium dioxide. The filler can be present in an amount up to about 40% based on the weight of the monomer.

The membrane can also include a wet surface adhesion modifier. The wet surface adhesion modifier provides for increased adhesion to wet surfaces. The wet surface adhesion modifier can be any material that increases the adhesion of the membrane to a wet surface. Suitable examples of the wet surface adhesion modifier include, but are not limited to, metallic acrylate or methacrylate at up to about 10% of total monomer content, ammonium oleate, magnesium oleate, ammonium acrylate and metal borates. A preferred wet surface adhesion modifier is zinc borate. The wet surface adhesion modifier is preferably present in an amount up to about 3% based on the weight of the monomer.

The membrane can also include a coloring agent, such as a pigment or a dye, to provide a desired color to the membrane. An example of a coloring agent is titanium dioxide, but other coloring agents are also useful. The coloring agent can be present in an amount up to about 3% based on the weight of the monomer.

The membrane can also include a defoamer such as modified silicones or petroleum oil mixtures. A preferred defoamer is FOAMASTER™ S available from Cognis Corporation, Cincinnati, Ohio. The defoamer can be present in an amount up to about 3% based on the weight of the monomer.

A preferred membrane is formed from a two component reaction mixture. The first component includes the monomer, the fire retardant, and the crosslinking agent that react to become the polymeric membrane and any other additive for example a second monomer, a smoke retardant, a rheology modifier, reaction rate modifier, a plasticizer, emulsifier, defoamer, filler, wet surface adhesion modifier, and coloring agent. The second component includes the initiator and any other additive. The two component mixture is preferred so that the monomer does not prematurely react with the initiator. To form the membrane, the two components are mixed and allowed to react.

When applied to a surface, the membrane should be at least about 1.5 mm thick. Preferably, the membrane is about 2 mm to about 6 mm thick.

One property of the membrane is elongation. Elongation is the percent increase in length of a membrane before it breaks (ASTM D638). It is desired to achieve elongation in the shortest amount of time. Preferably, the membrane has an elongation greater than about 25% after 24 hours from being formed. More preferably, the membrane has an elongation greater than about 50% after 8 hours. Most preferably, the membrane has an elongation greater than about 75% after 2 hours. In some embodiments, however, the membrane has an elongation of about zero. In these instances, the membrane is substantially rigid.

Another property of the membrane is tensile strength. Tensile strength is the maximum force that a membrane can withstand before breaking (ASTM D638). It is desired to achieve a high tensile strength. Preferably, the membrane has a tensile strength greater than about 1 MPa after 24 hours. More preferably, the membrane has a tensile strength greater than about 1 MPa after 6 hours. Most preferably, the membrane has a tensile strength greater than about 1 MPa after 30 minutes or less.

The membrane also has an adhesion property. Adhesion is measured by the force needed to remove the membrane from a surface (ASTM D4142). It is desired to achieve adhesion in the shortest amount of time. Preferably, the membrane has an adhesion strength greater than about 0.5 MPa after 24 hours. More preferably, the membrane has an adhesion strength greater than about 1 MPa after 8 hours. Most preferably the membrane has an adhesion strength greater than about 0.5 MPa after 30 minutes or less.

It is preferred that the membrane have water resistance. Water resistance can be determined by the following standards: ASTM D2247 (Standard Practice for Testing Water Resistance of Coatings in 100% Relative Humidity), ASTM D1735 (Standard Practice for Testing Water Resistance of Coatings Using Water Fog Apparatus), ASTM D4585 (Standard Practice for Testing Water Resistance of Coatings Using Controlled Condensation), or ASTM D870 (Standard Practice for Testing Water Resistance of Coatings Using Water Immersion).

The preferred standard is ASTM D870. A sample of the membrane is immersed in room temperature water for a period of about 24 hours. The tensile strength of the membrane is then measured and compared to the tensile strength of the membrane before immersion. Greater water resistance is indicated by having a lower loss in tensile strength. Acceptable water resistance is having a loss in tensile strength less than about 10%. Preferably, the loss in tensile strength is less than about 5%. It has been found that aryloxy alkyl acrylates and aryloxy alkyl methacrylates provide acceptable water resistance to the membrane of the present invention.

The membrane is also capable of quick set. By quick set it is meant that the membrane achieves at least one of the tensile, elongation, and adhesive properties within the time referenced above.

It is also preferred that the membrane have a useful service life greater than one year. By useful service life, it is meant that the membrane has less than about 10% loss of properties in one year.

Because the membrane may be applied underground in a mine, it is preferred that the membrane be non-toxic to human contact.

In another embodiment of the present invention there is provided a method of reinforcing exposed surfaces in an excavation with a polymeric structural support membrane. The method includes providing a mixture of a polymer that is an initiator induced reaction product of a monomer; a fire retardant; and optionally at least one of a crosslinking agent, a smoke retardant, a rheology modifier, reaction rate modifier, plasticizer, emulsifier, defoamer, filler, wet surface adhesion modifier, and coloring agent; wherein the monomer is selected from the group consisting of aryloxy alkyl acrylates, aryloxy alkyl methacrylates, and mixtures thereof; wherein the membrane has a tensile strength and a thickness sufficient to provide support to exposed surfaces in an excavation; and applying said mixture to an exposed surface in an excavation. This method provides for applying the above described polymeric structural support membrane on an exposed surface.

Sufficient membrane tensile strength and thickness to provide support for exposed surfaces in an excavation can be measured using the testing method illustrated in A. Spearing, Jeffrey Ohler & Emmanuel Attiogbe, The effective testing of thin support membranes (superskins) for use in underground mines, Australian Centre for Geomechanics, herein incorporated by reference. The test, referred to as MBT Membrane Displacement Test, is designed to provide load and displacement data on membrane performance to account for the combined effects of tensile strength, elongation and adhesion properties of spray-on membranes and provide performance data for evaluating such membranes. It is effective in comparing the relative performance of different membranes. The membrane is sprayed onto the surface of a concrete slab. An area of the applied membrane is then subjected to a load. Both short-and long-term (i.e., creep) tests can be performed with the test setup. For ease of developing a standard test that can be routinely used to assess the overall performance of spray-on membranes, pre-cast concrete slabs are used. These slabs are commercially available and are quite dense (relative to normal cast-in-place concrete) with a slightly textured finish on one surface. Typical values of absorption and volume of permeable pore space for the slabs, as determined in accordance with ASTM C 642, are 5% and 11%, respectively. Using the pre-cast slab, the performance of the membrane can be evaluated for the effects of variations in membrane properties, as well as the effects of substrate moisture conditions.

The mixture can be applied by spraying, brushing, or rolling to provide the polymeric structural support membrane on an exposed surface. A preferred embodiment of the present invention is prepared from the following formulation. It is provided in the preferred two component formulation with the monomer and initiator being provided in separate parts to the formulation.

PART A

| | |
|---|---|
| 2-phenoxyethyl methacrylate | Monomer |
| ethoxylated bisphenol A dimethacrylate | Cross-linking agent |
| N,N-Dimethyl-P-Toluidine | Reaction rate modifier |
| natural graphite flake | Flame retardant/fire retardant |
| fumed silica | Rheology modifier |
| mineral oil (light naphthenic) | Rheology modifier |
| titanium dioxide | Coloring agent, filler |
| zinc borate | Wet surface adhesion modifier |
| FOAMASTER S | Defoamer |

PART B

| | |
|---|---|
| tri(2-chloroethyl)phosphate | Fire retardant |
| mineral oil (light naphthenic) | Rheology modifier |
| benzoyl peroxide | Initiator |
| fumed silica | Rheology modifier |
| zinc borate | Wet surface adhesion modifier |
| FOAMASTER S | Defoamer |

In another preferred embodiment, the present invention is prepared from the following formulation. Again, this embodiment is provided in the preferred two component formulation with the monomer and initiator being provided in separate parts to the formulation.

PART A

| | |
|---|---|
| 2-phenoxyethyl methacrylate | Monomer |
| ethoxylated bisphenol A dimethacrylate | Cross-linking agent |
| or trimethylolpropane trimethacrylate | |
| N,N-Dimethyl-P-Toluidine | Reaction rate modifier |
| ethoxylated(4) nonyl phenol | Plasticizer |
| (meth)acrylate | |
| polyammonium phosphate/Al₂O₃ | Fire retardant/smoke retardant |
| fumed silica | Rheology modifier |
| mineral oil (light naphthenic) | Rheology modifier |
| titanium dioxide | Coloring agent, filler |
| zinc borate | Wet surface adhesion modifier |
| FOAMASTER S | Defoamer |

PART B

| | |
|---|---|
| polyammonium phosphate/Al₂O₃ | Fire retardant/smoke retardant |
| benzoyl peroxide | Initiator |
| mineral oil (light naphthenic) | Rheology modifier |
| fumed silica | Rheology modifier |
| zinc borate | Wet surface adhesion modifier |
| FOAMASTER S | Defoamer |

In another preferred embodiment, the present invention has the following three component formulation. The three component formulation comprises the monomer, initiator and reaction rate modifier which are provided in separate parts to the formulation. This embodiment can additionally contain filler, rheology modifiers, a second monomer, and coloring agents.

PART A

| | |
|---|---|
| 2-phenoxyethyl methacrylate | Monomer |
| trimethylolpropane trimethacrylate | Cross-linking agent |
| polyammonium phosphate/Al₂O₃ | Fire retardant/smoke retardant |
| fumed silica | Rheology modifier |
| Aluminium Oxide | Smoke retardant |
| FOAMASTER S | Defoamer |

PART B

| | |
|---|---|
| diethylene glycol monoethylether | Non-homopolymerizable monomer |
| methacrylate | |
| benzoyl peroxide | Initiator |
| fumed silica | Rheology modifier |
| Aluminium Oxide | Smoke retardant |
| FOAMASTER S | Defoamer |

PART C

| | |
|---|---|
| diethylene glycol monoethylether | Non-homopolymerizable monomer |
| methacrylate | |
| N,N, Dimethyl P Toluidine | Reaction rate modifier |
| FOAMASTER S | Defoamer |

In another preferred embodiment the formulation comprises four components. This embodiment is provided in a four component formulation combined in two units of monomer, initiator and reaction rate modifier, as discussed below.

PART A

| | |
|---|---|
| 2-phenoxyethyl methacrylate | Monomer |
| trimethylolpropane trimethacrylate | Cross-linking agent |
| polyammonium phosphate/Al₂O₃ | Fire retardant/smoke retardant |
| fumed silica | Rheology modifier |
| Aluminium Oxide | Smoke retardant |
| FOAMASTER S | Defoamer |
| titanium dioxide | Coloring Agent, filler |

PART B

| | |
|---|---|
| diethylene glycol monoethylether | Second monomer |
| methacrylate | |
| N,N, Dimethyl P Toluidine | Reaction rate modifier |
| fumed silica | Rheology modifier |
| titanium dioxide | Coloring Agent, filler |

PART C

| | |
|---|---|
| 2-phenoxyethyl methacrylate | Monomer |
| fumed silica | Rheology modifier |
| titanium dioxide | Coloring Agent, filler |

PART D

| | |
|---|---|
| benzoyl peroxide | Initiator |
| diethylene glycol monoethylether | Second monomer |
| methacrylate | |
| fumed silica | Rheology modifier |
| titanium dioxide | Coloring Agent, filler |
| polyammonium phosphate/Al₂O₃ | Fire retardant/smoke retardant |

Preferably, this embodiment can be reacted to form the membrane of the present invention by supplying the four components through a pump that delivers the materials to a spraying apparatus to spray the formulation onto a surface. Generally, the pump is designed to pump two components simultaneously. Components one (PART A) and two (PART B) are supplied to one pumping chamber of the pump, and components three (PART C) and four (PART D) are supplied to a second pumping chamber of the pump. The volumes of the components are sized such that the membrane is formed with the desired composition. In a preferred embodiment, a pump is used that delivers two combinations of components (units) in the volume ratio of about 3 to 1. In this embodiment, components one and two are sized to provide a unit of ¾ of the total volume of the material delivered that forms the membrane, and components three and four are sized to provide a unit of ¼ of the total volume.

### EXAMPLE

An example of the present inventive polymeric structural support membrane was tested for tensile strength ASTM D638 and elongation ASTM D638 both in the presence of water and without water. The example of the invention comprises two components (3 parts of Part A to 1 part of Part B (by weight)) which were added together to react and form the support membrane. In part A three monomers were used in order to maximize the flexibility (elongation), strength (tensile strength) and water sensitivity of the structural support membrane. 2-phenoxyethyl methacrylate imparts decreased water sensitivity but lacks strength and flexibility whereas, the remaining two monomers hydroxy propyl methacrylate and isobornyl methacrylate give the membrane strength and flexibility.

TABLE 1

% of total
mixture weight

Part A

| | | |
|---|---|---|
| Monomer (mixture) | 2-phenoxyethyl methacrylate | 37.59 |
| | hydroxy propyl methacrylate | 22.55 |
| | isobornyl methacrylate | 15.04 |
| Cross-linking agent | ethyoxylated bisphenol A | 3.78 |
| | dimethacrylate | |
| Reaction rate modifier | N,N-dimethyl-p-toluidine | 0.53 |
| Flame retardant/ | Grafguard 220-80B | 5.66 |
| self-extinguishing agent | | |
| Rheology modifier | Bentone 38 | 11.71 |
| | Aerosil R 202 | 1.89 |
| Coloring agent, filler | Titanium dioxide | 0.90 |
| Defoamer | Foamaster S | 0.35 |

Part B

| | | |
|---|---|---|
| Self-extinguishing agent | tri(2-chloroethyl)phosphate | 74.63 |
| Initiator | benzoyl peroxide | 14.93 |
| Rheology modifier | Bentone 38 | 7.46 |
| | Aerosil R 202 | 2.98 |

TABLE 2
Measured Membrane Property

| | @ 1 hr. | @ 1 day | @ 7 days |
|---|---|---|---|
| Air Cure | | | |
| Tensile strength (MPa) | 1.3 | 1.5 | 1.3 |
| Elongation (%) | 140 | 129 | 113 |
| Moist Cure | | | |
| Tensile strength (MPa) | | 1.5 | 1.1 |
| Elongation (%) | | 120 | 136 |

The example was tested for elongation (ASTM D638)—the percent increase in length of a membrane before it breaks, and tensile strength (ASTM D638)—the maximum force that a membrane can withstand before breaking expressed in megapascals. As illustrated by the results in Table 2, the polymeric structural support membrane achieves the desired tensile strength (greater than 1 MPa after 24 hours) and elongation (greater than about 25% after 24 hours). Therefore, the membrane will display the desired strength and flexibility for an underground structural support. Additionally, the test results demonstrate that the polymeric structural support membrane shows little or no strength loss when exposed to water (moisture sensitivity).

Although the invention has been described in detail through the above detailed description and the preceding formulations and example, these examples are for the purpose of illustration only and it is understood that variations and modifications can be made by one skilled in the art without departing from the spirit and the scope of the invention.

What is claimed is:

1. A polymeric excavation structural support membrane comprising a polymer that is an initiator induced reaction product of a monomer; a fire retardant; and optionally at least one of a crosslinking agent, a second monomer, a smoke retardant, a rheology modifier, a reaction rate modifier, a plasticizer, an emulsifier, a defoamer, a filler, a wet surface adhesion modifier, and a coloring agent; wherein the monomer is selected from the group consisting of aryloxy alkyl acrylates, aryloxy alkyl methacrylates, and mixtures thereof; wherein the second monomer does not homopolymerize in the presence of the reaction rate modifier or the initiator; wherein the membrane has a tensile strength and thickness sufficient to provide support to exposed surfaces in an excavation.

2. The polymeric structural support membrane of claim 1, wherein the membrane comprises a polymer that is an initiator induced reaction product of a monomer, a crosslinking agent; a fire retardant; and optionally at least one of a second monomer, a smoke retardant, a rheology modifier, a reaction rate modifier, a plasticizer, an emulsifier, a defoamer, a filler, a wet surface adhesion modifier, and a coloring agent; wherein the monomer is selected from the group consisting of monofunctional aryloxy alkyl acrylates, monofunctional aryloxy alkyl methacrylates, and mixtures thereof.

3. The polymeric structural support membrane of claim 1 or 2, wherein the polymer is present in an amount from about 30% to about 70% by weight of the membrane, the self extinguishing additive is present from about 5% to about 40% by weight of the membrane, the initiator is present from about 1 to about 10% by weight of the monomer.

4. The polymeric structural support membrane of claim 2, wherein the monofunctional aryloxy alkyl methacrylates are selected from the group consisting of 2-phenoxyethyl methacrylate 2-phenoxy-propyl-methacrylate, and mixtures thereof.

5. The polymeric structural support membrane of claim 1 or 2, wherein the fire retardant is selected from the group consisting of phosphates, exfoliated graphite, and mixtures thereof.

6. The polymeric structural support membrane of claim 5, wherein the phosphate is selected from the group consisting of polyammonium phosphate, monoammonium phosphate, triphenyl phosphate, and tri(2-chloroethyl) phosphate.

7. The polymeric structural support membrane of claim 1 or 2, wherein the initiator is an oxidizing agent.

8. The polymeric structural support membrane of claim 7, wherein the oxidizing agent is selected from the group consisting of peroxides, hydroperoxides, persulfates, and mixtures thereof.

9. The polymeric structural support membrane of claim 8, wherein the peroxide is selected from the group consisting of benzoyl peroxide and dibenzoyl peroxide.

10. The polymeric structural support membrane of claim 8, wherein the persulfate is ammonium persulfate.

11. The polymeric structural support membrane of claim 8, wherein the hydroperoxide is cumyl hydroperoxide.

12. The polymeric structural support membrane of claim 1 or 2, wherein the crosslinking agent is selected from methylene bis acrylamide, polymethylmethacrylate, butadiene styrene acrylate, styrene butyl acrylate copolymer, 1,6-hexanediol dimethacrylate, ethoxylated bisphenol A dimethacrylate, polyethylene glycol dimethacrylate, and mixtures thereof.

13. The polymeric structural support membrane of claim 1 or 2, wherein the second monomer is selected from the group consisting of diethylene glycol monoethyl ether dimethacrylate, diethylene glycol monobutyl ether dimethacrylate, and mixtures thereof.

14. The polymeric structural support membrane of claim 1 or 2, wherein the smoke retardant is aluminum oxide.

15. The polymeric structural support membrane of claim 1 or 2, further characterized by at least one of the following:
a. the crosslinking agent is present up to about 30% by weight of the monomer;
b. the rheology modifier is present up to about 10% by weight of the monomer;
c. the emulsifier is present up to about 5% by weight of the monomer;
d. the plasticizer is present up to about 40% by weight of the monomer;
e. the filler is present up to about 40% by weight of the monomer;
f. the wet surface adhesion modifier is present up to about 3% by weight of the monomer;
g. the coloring agent is present up to about 3% by weight of the monomer;
h. the defoamer is present up to about 3% by weight of the monomer;
i. the reaction rate modifier is present up to about 10% by weight of the monomer; and
j. the smoke retardant is present up to about 10% by weight.

16. The polymeric structural support membrane of claim 1 or 2, wherein the emulsifier is selected from the group consisting of anionic surfactants, nonionic surfactants, and mixtures thereof.

17. The polymeric structural support membrane of claim 16, wherein the emulsifier is selected from the group consisting of ethoxylated nonyl phenol, lauryl sulfates, and mixtures thereof.

18. The polymeric structural support membrane of claim 1 or 2, wherein the rheology modifier is selected from the group consisting of fumed silica, hydroxyethyl cellulose, hydropropyl cellulose, fly ash, mineral oil, tetra alkyl ammonium hectorite clay, and mixtures thereof.

19. The polymeric structural support membrane of claim 1 or 2, wherein the reaction rate modifiers are reducing agents.

20. The polymeric structural support membrane of claim 19, wherein the reducing agents are selected from the group consisting of anilines, amines, glycols, octoates, and mixtures thereof.

21. The polymeric structural support membrane of claim 1 or 2, wherein the filler is selected from the group consisting of crushed glass, metal such as iron particles, quartz, silica, barytes, limestone, sulfates, alumina, various clays, diatomaceous earth, wollastonite, mica, perlite, flint powder, kryolite, alumina trihydrate, talc, sand, pyrophylite, granulated polyethylene, fibers such as polypropylene or steel, aluminum oxide, zinc oxide, titanium dioxide, and mixtures thereof.

22. The polymeric structural support membrane of claim 1 or 2, wherein the wet surface adhesion modifier is selected from the group consisting of metallic acrylate, metallic methacrylate, ammonium oleate, magnesium oleate, ammonium acrylate, metal borates, and mixtures thereof.

23. The polymeric structural support membrane of claim 1 or 2, wherein the plasticizer is selected from the group consisting of lauryl methacrylates, stearyl methacrylates, ethoxylated(4) nonyl phenol (meth)acrylate, and mixtures thereof.

24. The polymeric structural support membrane of claim 1 or 2, wherein the membrane is at least about 1.5 mm thick.

25. The polymeric structural support membrane of claim 24, wherein the membrane is about 2 mm to about 6 mm thick.

26. The polymeric structural support membrane of claim 1 or 2, wherein the membrane is characterized by at least one of:
a. an elongation greater than about 25% after about 24 hours from being formed;
b. an elongation greater than about 50% after about 8 hours from being formed;
c. an elongation greater than about 75% after about 2 hours from being formed;
d. a tensile strength greater than about 1 MPa after about 24 hours from being formed;
e. a tensile strength greater than about 1 MPa after about 6 hours from being formed;
f. a tensile strength greater than about 1 MPa within about 30 minutes from being formed;
g. an adhesion strength greater than about 0.5 MPa after about 24 hours from being formed;
h. an adhesion strength greater than about 1 MPa after about 8 hours from being formed;
i. an adhesion strength greater than about 0.5 MPa within about 30 minutes from being formed; and
j. a water resistance as measured by having less than about 5% loss of tensile strength when immersed in room temperature water for about 24 hours.

27. The polymeric structural support membrane of claim 1 or 2, wherein the membrane is a reaction product of a first component and a second component; wherein the first component comprises a monomer, a crosslinking agent, a reaction rate modifier, a self-extinguishing agent, a rheology modifier, a filler, and a defoamer; and the second component comprises an initiator, a self-extinguishing agent, a rheology modifier, a wet surface adhesion modifier, and a defoamer.

28. The polymeric structural support membrane of claim 27, wherein the first component comprises 2-phenoxyethyl methacrylate, ethoxylated bisphenol A dimethacrylate, N,N-Dimethyl-P-Toluidine, natural graphite flake, fumed silica, mineral oil, titanium dioxide, zinc borate, smoke retardant, and defoamer; and wherein the second component comprises tri(2-chloroethyl) phosphate, mineral oil, benzoyl peroxide, fumed silica, zinc borate, and defoamer.

29. The polymeric structural support membrane of claim 27, wherein the first component comprises 2-phenoxyethyl methacrylate, at least one of ethoxylated bisphenol A dimethacrylate and trimethylolpropane trimethacrylate, N,N-Dimethyl-P-Toluidine, ethoxylated(4) nonyl phenol (meth)acrylate, polyammonium phosphate, aluminum oxide, fumed silica, mineral oil, titanium dioxide, zinc borate, and defoamer; and wherein the second component comprises polyammonium phosphate, aluminum oxide, mineral oil, benzoyl peroxide, fumed silica, zinc borate, and defoamer.

30. The polymeric structural support membrane of claim 1 or 2, wherein the membrane is a reaction product of a first component, a second component, and a third component; wherein the first component comprises a first monomer, a crosslinking agent, a self-extinguishing agent, a smoke retardant, a rheology modifier, and a defoamer; and the second component comprises a second monomer, an initiator, a rheology modifier, a smoke retardant, and a defoamer; and the third component comprises the second monomer, a reaction rate modifier, and a defoamer, wherein the second monomer comprises at least one monomer other than the first monomer.

31. The polymeric structural support membrane of claim 30, wherein the first component comprises 2-phenoxyethyl methacrylate, trimethylolpropane trimethacrylate, polyammonium phosphate, aluminum oxide, fumed silica, and defoamer; and the second component comprises diethylene glycol monoethylether methacrylate, benzoyl peroxide, fumed silica, aluminum oxide, and defoamer; and the third component comprises diethylene glycol monoethylether methacrylate, N,N, Dimethyl P Toluidine, and defoamer.

32. The polymeric structural support membrane of claim 1 or 2, wherein the membrane is a reaction product of a first component, a second component, a third component, and a fourth component; the first component comprises a first monomer, a cross-linking agent, a fire retardant, a rheology modifier, a smoke retardant, a coloring agent, a filler, and a defoamer; the second component comprises a reaction rate modifier, a second monomer, a rheology modifier, a coloring agent, and a filler; the third component comprises the first monomer, a rheology modifier, a coloring agent, and a filler; and the fourth component comprises an initiator, the second monomer, a rheology modifier, a fire retardant, a smoke retardant, a coloring agent, and a filler, wherein the second monomer comprises at least one monomer other than the first monomer, and wherein the first monomer comprises at least one monomer other than the second monomer.

33. The polymeric structural support membrane of claim 32, wherein the first component comprises 2-phenoxyethyl methacrylate, trimethylolpropane trimethacrylate, polyammonium phosphate, fumed silica, aluminum oxide, titanium dioxide and defoamer; the second component comprises N,N, Dimethyl P Toluidine, diethylene glycol monoethylether methacrylate, fumed silica, titanium dioxide; and the third component comprises 2-phenoxyethyl methacrylate, fumed silica, titanium dioxide; and the fourth component comprises benzoyl peroxide, diethylene glycol monoethylether methacrylate, fumed silica, polyammonium phosphate, aluminum oxide, and titanium dioxide.

34. A method of reinforcing exposed surfaces in an excavation with a polymeric structural support membrane comprising:
a. applying to the exposed surface a mixture comprising a monomer; an initiator, a fire retardant; and optionally at least one of a crosslinking agent, a second monomer, a smoke retardant, a rheology modifier, a reaction rate modifier, a plasticizer, an emulsifier, a defoamer, a filler, a wet surface adhesion modifier, and a coloring agent; wherein the monomer is selected from the group consisting of aryloxy alkyl acrylates, aryloxy alkyl methacrylates, and mixtures thereof, wherein the second monomer does not homopolymerize in the presence of the reaction rate modifier or the initiator; and
b. reacting the mixture;
wherein the membrane has a tensile strength and thickness sufficient to provide support to the exposed surfaces in the excavation.

35. The method of claim 34, wherein said applying is selected from the group consisting of spraying, brushing, rolling, and combinations thereof.

36. The method of claim 34, wherein the tensile strength is at least 1 MPa and the thickness is about 1.5 mm to about 6 mm.

37. The method of claim 34 further defined by four components, wherein:
a. the first component comprises a first monomer, a cross-linking agent, a fire retardant, a rheology modifier, a smoke retardant, a coloring agent, a filler, and a defoamer; the second component comprises a reaction rate modifier, a second monomer, a rheology modifier, a coloring agent, and a filler; the third component comprises the first monomer, a rheology modifier, a coloring agent, and a filler; and the fourth component comprises an initiator, the second monomer, a rheology modifier, a fire retardant, a smoke retardant, a coloring agent, and a filler, wherein the second monomer comprises at least one monomer other than the first monomer, and wherein the first monomer comprises at least one monomer other than the second monomer;
b. components one and two are supplied to one chamber of a pumping means, and components three and four are supplied to a second chamber of said pumping means;
c. said pumping means delivers the materials to a spraying apparatus to spray the formulation onto a surface;
d. components one, two, three, and four are then sprayed onto a surface where they react to form the membrane;
wherein the membrane has a tensile strength and thickness sufficient to provide support to the exposed surfaces in the excavation.

38. The method of claim 37 wherein the pumping means combines components one and two as a first unit and components three and four as a second unit in a volume ratio of about 3 to 1.

39. The method of claim 38 further characterized in that components one and two provide ¾ of the total volume of the material delivered that forms the membrane, and components three and four provide ¼ of the total volume.

40. A polymeric structural support membrane formed from the process comprising:
a. applying to an exposed surface in an excavation a mixture comprising a monomer; an initiator, a fire retardant; and optionally at least one of a crosslinking agent, a second monomer, a smoke retardant, a rheology modifier, reaction rate modifier, a plasticizer, emulsifier, defoamer, filler, wet surface adhesion modifier, and coloring agent; wherein the monomer is selected from the group consisting of aryloxy alkyl acrylates, aryloxy alkyl methacrylates, and mixtures thereof, wherein the second monomer does not homopolymerize in the presence of the reaction rate modifier or the initiator; and
b. reacting the mixture;
wherein the membrane has a tensile strength and thickness sufficient to provide support to the exposed surfaces in the excavation.

41. The polymeric structural support membrane of claim 40, wherein the tensile strength is at least 1 MPa and the thickness is about 1.5 mm to about 6 mm.
